(19) United States
(12) Patent Application Publication
(10) Pub. No.: US 2006/0126901 A1
(43) Pub. Date: Jun. 15, 2006

(54) Device for determining the age of a person by measuring pupil size

(76) Inventors: Bernhard Mattes, Sachsenheim (DE); Thomas Lich, Schwaikheim (DE); Frank Mack, Stuttgart (DE); Markus Fislage, Leonberg (DE)

Correspondence Address: KENYON & KENYON LLP, ONE BROADWAY, NEW YORK, NY, 10004, US

(21) Appl. No.: 10/523,901

(22) PCT Filed: Mar. 18, 2003
(86) PCT No.: PCT/DE03/00871

§ 371 Date: Aug. 17, 2005

(30) Foreign Application Priority Data
Aug. 10, 2002 (DE) 102 36 769.8

(51) Int. Cl. G06K 9/00; G06K 9/46

(52) U.S. Cl. 382/104; 382/190

(57) ABSTRACT

An apparatus for determining physiological data is provided for determining age of a vehicle passenger in the context of safety apparatus deployment. For picking up the physiological data, a sensor is used. In particular, the apparatus is configured for measuring the pupil size, which is a good parameter for distinguishing age. This parameter may be correlated with further measured values, in order to put the age determination on a reliable basis.

### FIELD OF THE INVENTION

The present invention provides an apparatus for picking up physiological data of at least one person in a vehicle.

### SUMMARY

The apparatus of the present invention for picking up physiological data of at least one person has the advantage that the apparatus is configured such that on the basis of the physiological data, it performs a determination of the age of the at least one person. Thus, it is possible to activate such restraint devices as air bags and belt tighteners in a way adapted to the situation. Since the bones of a human being become more fragile with age, it is advantageous for the air bag in the event of a crash, if an older person is detected, to be blown up less powerfully than for a younger person. Bone flexibility in people over 50 is only approximately 30% of the bone flexibility of 25-year- olds. When the belt tighteners are tripped, the ribs of older passengers may be broken, and there is the risk of internal bleeding if the belt force limiter is not immediately switched on.

Besides its use in vehicles, the apparatus of the present invention may also be employed for instance in age-dependent access release devices or age-dependent dispensing of consumer goods.

However, the apparatus of the present invention is explained herein in the context of use in the vehicle.

It is especially advantageous that the at least one sensor, which is used for picking up the physiological data, is embodied as an image transducer. A video sensor, in particular a stereo video sensor, is used, which by triangulation is capable of determining the spacing of the person from an air bag cover and in particular of determining his pupil size. To that end, an evaluation module which is configured for measuring the pupil size is associated with the image transducer or video sensor. From the pupil size, it is simple to draw a conclusion about the age of the applicable person. It is known that the pupil size decreases with age. In the elderly, it may shrink to as little as one-third its youthful size.

Instead of the stereo video sensor, still other methods are conceivable that combine a video sensor with a spacing measurement. For spacing measurement, other methods may be used for triangulation, for instance using structured lighting or transit time processes, such as LIDAR, imaging LIDAR, radar or ultrasound, or interferometry methods, in other words spacing measurement on the basis of the phase displacement of two laser beams on the basis of their different light travel distances.

Advantageously, the apparatus of the present invention may combine the image transducer with further sensors, in order either to obtain other data for triggering the restraint devices adaptively to the situation or to correlate the pupil size with other physiological data, in order to put the age determination on a better basis. To that end, it is for instance possible, from the image signal, e.g., video signal, to evaluate the hair color and/or smoothness of the face and/or skin texture. A classifier may also be trained to assign the persons to various age classes on the basis of the image signal.

The measured values alone may give a false impression of the age of the person, but in correlation with the pupil size, for example, these parameters are capable of making the age determination more reliable.

As further measured values, the pulse rate, which is ascertained by a pressure pickup, or electrical parameters, such as the electrical resistance of the skin or a capacitance measurement to determine the proportion of water in the body, may be used. The proportion of water in the body also indicates a variable age in a person, since the proportion of water in older persons drops to 60% of the body weight, compared to 90% in children.

It is furthermore advantageous if the apparatus of the present invention employs measured values from a weight measurement of the person in order to draw a conclusion about the age of that person. The weight measurement may be performed with a mat on the seat or with force measuring pins or other sensors for determining the mass.

### DESCRIPTION OF THE DRAWINGS

FIG. 1 shows a block diagram of the apparatus of the present invention.

FIG. 2 shows a schematic illustration of the apparatus of the present invention in the vehicle.

### DETAILED DESCRIPTION

Particularly with the introduction of front-passenger air bags, the necessity has arisen, for reasons of safety and insurance, of detecting a front-passenger seat occupied by a person. In an accident, if that seat is not occupied, no passenger needs protection, and it would therefore entail unnecessarily high repair costs if the air bag were to be deployed. Seat occupation detection for detecting a person is widely employed for this purpose. Some ideas for automatic detection of a child seat also already exist.

According to the present invention, the apparatus for picking up physiological data is now configured in such a way that it becomes possible to determine the age of the passenger, that is, the person in the vehicle. However, the apparatus of the present invention may also be employed outside the vehicle. Inside the vehicle, however, determining the age in the event of an accident makes it possible to activate the restraint devices in a way adapted to the situation and the persons involved.

Analyzing the size of the pupils of a person, e.g., by an image transducer such as a video system, and combining this information with other measured values independent of it, makes it possible to determine the age of a person. Especially since the size of the pupils decreases sharply with age, this is a good parameter for detecting an older person. The following table shows how the pupil cross section decreases with increasing age.

TABLE 1
Pupil diameter in persons of various ages

| Age (years) | Day (mm) | Night (mm) | Difference |
|---|---|---|---|
| 20 | 4.7 | 8.0 | 3.3 |
| 30 | 4.3 | 7.0 | 2.7 |
| 40 | 3.9 | 6.0 | 2.1 |
| 50 | 3.5 | 5.0 | 1.5 |
| 60 | 3.1 | 4.1 | 1.0 |
| 70 | 2.7 | 3.2 | 0.5 |
| 80 | 2.3 | 2.5 | 0.2 |

Thus, according to the present invention, the targeted protection of older persons in a car accident becomes possible. This protection of older persons is much more important than detecting their sex, since for instance women who are not pregnant withstand higher accelerations and pressures per unit of surface area than men of the same age, and consequently do not require air bag protection until at higher impact speeds.

Especially with the aid of a stereo video sensor, by triangulation, it is possible to ascertain the spacing of the passenger from the air bag cover and the size of the pupils of a person. Alternatively, the size of the pupils may be ascertained with a video camera in combination with an ultrasound spacing sensor. In both cases, it is provided to focus on the eyes of the person with the video system and follow them and measure their size at certain intervals. The brightness in the vehicle may be estimated on the basis of known areas in the vehicle, such as the vehicle's headlining. An estimate of the age may be made with the aid of the brightness in the vehicle and the size of the pupils. Chronological filtering minimizes the inaccuracy of this age estimate to brief fluctuations in brightness. For persons who wear glasses, the size of the pupils may still be determined relatively accurately despite the distortion, for instance if the size of the eye and the iris are used as a reference and the distortion from the glasses is eliminated by reverse calculation.

The apparatus according to the present invention may also provide that the measurement of the pupil size for estimating the age is combined with other measured values in order to obtain redundance and greater certainty in the determination. These additional measured values may on the one hand originate in the same video system, examples being the hair color, deep wrinkles in the face, circles under the eye, or the texture of the skin. However, these measured values may also originate in other sensor systems. For instance, this may involve measuring the pulse of the vehicle driver, using pressure sensors in the steering-wheel rim. In older persons, the pulse is slower than in younger persons. As the pressure pickup, piezoelectric sensors may also be used, disposed for instance in the seats.

Measuring the properties of the hands may be done for the driver using sensors for measuring the electrical resistance, that is, the skin resistance between defined spacings, e.g., 2 cm, for measuring the temperature, and for measuring the distribution of contact pressure on the steering-wheel rim. In this way as well, it is possible to generate at least one indicator of the age of the person measured.

A further embodiment is to detect the displacement currents, that is, the capacitance between transmitting and receiving electrodes in the seat, in an electrical field. For a passenger detected with the video system, for instance, the proportion of water in his body may be determined from the measurement of capacitance. A lesser capacitance in the electrical field means a lesser proportion of water and is thus an indication of an older person, since the proportion of water in older persons usually amounts to only 60%, compared to 90% in children.

With a video system for determining the stature of a passenger and an absolute weight sensing system, for instance using a force measuring pin in the seat height adjusting linkages or between the seat rail and seat rocker, the proportion between passenger weight and passenger stature may be ascertained. If this proportion is below a limit value, still another indication of an older person is obtained.

Measuring the pupil size, however, may be the most important building block in determining the age. However, the pupils may atypically be dilated for several hours from the effect of medication, for instance after an examination of the retina made by an ophthalmologist. Measuring the pupils alone would then lead to an incorrect result, with unwanted, adverse consequences to old passengers if the passenger protection is activated in the event of a crash.

For reliable anthropometric and nonintrusive determination of age, it is therefore necessary also to take into account the inputs of the aforementioned further sensors, or some of these sensors.

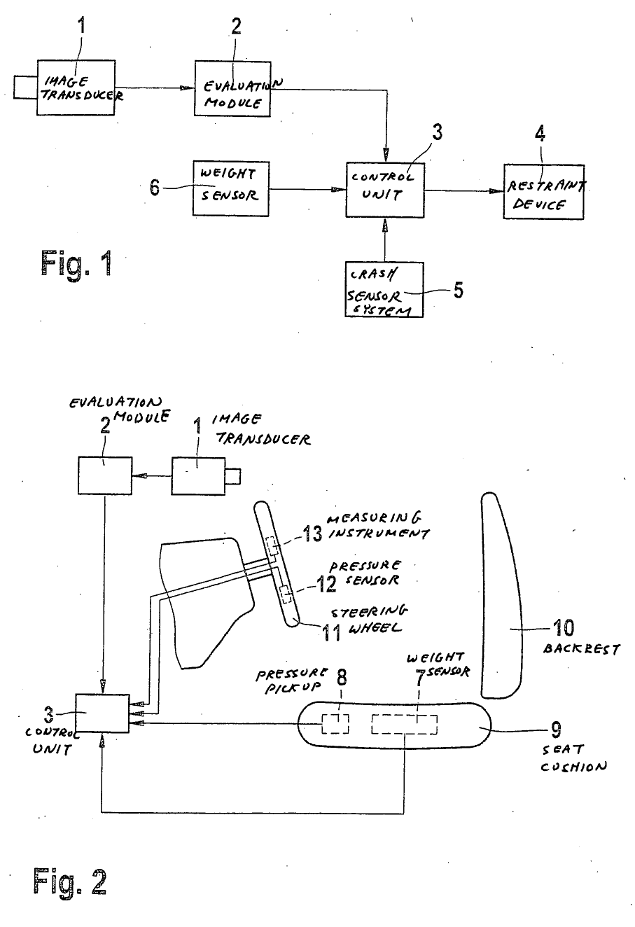

FIG. 1 shows a block diagram of the apparatus of the present invention. An image transducer 1 is connected to an evaluation module 2 via a data output. Evaluation module 2 is connected to a first data input of a control unit 3, which includes a processor. A weight sensor 6, which determines the weight of a vehicle passenger in the seat, is connected to a second data input of control unit 3. This weight sensor is a force measuring pin, which is disposed in the seat height adjusting linkages. Control unit 3 serves to trigger restraint devices, so that control unit 3 is connected to restraint devices 4 via one data output. Via a third data input, control unit 3 is connected to crash sensor system 5, for detecting a crash. Besides inertial sensors, precrash sensors or deformation sensors may be present in crash sensor system 5. Besides weight sensors 6, which may also be embodied as a mat on the seat, still other sensors are possible, for instance for picking up the pulse of the person or electrical sensors for determining the skin impedance or capacitance of the person involved. Image transducer 1 is embodied here as a stereo video sensor, which, by triangulation, determines the pupil size of the person involved and that person's spacing from an air bag cover. This calculation is performed in particular by evaluation module 2, embodied here as a microcontroller. Module 2 may also be disposed in control unit 3 itself, and for instance may also simply be software in a central processor in control unit 3. By image transducer 1 and optionally further sensors, as described above, control unit 3 determines the age of the applicable person. In the event of a crash, control unit 3 will then trigger the applicable air bag or belt tightener to suit the age of the person, as a function of this age determination. FIG. 2 shows a configuration of the apparatus of the present invention in the vehicle. Identical components as those shown in FIG. 1 again have the same reference numerals. Image transducer 1 is connected via the data output to evaluation module 2, which in turn is connected to a first data input of control unit 3. A weight sensor 7 is connected to a second data input of control unit 3 and is located in a seat cushion 9 of a vehicle seat. A pressure pickup 8 is connected to a third data input of control unit 3 and is intended for measuring the pulse rate of the driver seated on the seat. A pressure sensor 12 is connected to a fourth data input of control unit 3, so as to measure the driver's pulse at steering wheel 11. An impedance measuring instrument 13 is also disposed in steering wheel 11, and it is connected to a fifth data input of control unit 3 in order to determine the impedance of the skin. Further sensor types already named above may be employed here. It is also possible to use fewer sensors than those described here. Sensors may also be built into backrest 10 of the seat. In particular, an ultrasound spacing meter may be employed here.

1-11. (canceled)

12. An apparatus for obtaining physiological data of at least one person, comprising:
at least one sensor for detecting the physiological data; and
a control unit for determining, on the basis of the physiological data, the age of the at least one person.

13. The apparatus as recited in claim 12, wherein the at least one sensor is an image transducer.

14. The apparatus as recited in claim 13, wherein the image transducer is a stereo video sensor, and wherein the video sensor is assigned an evaluation module configured to measure the pupil size of the at least one person, and the pupil size is utilized in determining the age.

15. The apparatus as recited in claim 14, wherein the video sensor is configured for triangulation measurement.

16. The apparatus as recited in claim 13, further comprising:
an ultrasound spacing sensor for measuring the spacing of the at least one person from an air bag cover.

17. The apparatus as recited in claim 14, wherein the control unit correlates the measurement of the pupil size with at least one further measured value for determining the age.

18. The apparatus as recited in claim 17, wherein the control unit uses hair color, smoothness of face, and skin texture of the at least one person as the at least one further measured value.

19. The apparatus as recited in claim 17, further comprising:
a pressure pick-up for measuring a pulse rate of the at least one person, wherein the control unit uses the pulse rate of the at least one person as the at least one further measured value.

20. The apparatus as recited in claim 19, wherein the pressure pick-up is positioned in one of a steering wheel and in a vehicle seat.

21. The apparatus as recited in claim 17, wherein the at least one further measured value includes an electrical parameter of the at least one person.

22. The apparatus as recited in claim 17, wherein the at least one further measured value includes a weight of the at least one person.
